(19) United States
(12) Patent Application Publication
(10) Pub. No.: US 2011/0145686 A1
(43) Pub. Date: Jun. 16, 2011

(54) TERM-SPECIFIC NAVIGATION SYSTEM AND METHOD FOR INFORMATION SEARCHING

(75) Inventor: John R. Wullert, II, Martinsville, NJ (US)

(73) Assignee: TELCORDIA TECHNOLOGIES, INC., Piscataway, NJ (US)

(21) Appl. No.: 12/638,243

(22) Filed: Dec. 15, 2009

(51) Int. Cl. G06F 3/14; G06F 17/30; G06F 17/00

(52) U.S. Cl. 715/205; 707/758; 707/706; 715/234; 707/E17.014; 707/E17.108

(57) ABSTRACT

A term-specific navigation method and system is provided for information searching by a user of an Internet browser, that modifies, by using a processor, a copy of Internet content identified as a result of a specific user's search to mark in that copy the locations of a user's search terms; and provides the user with one or more links that will direct the user's browser to the locations in the copy where the user's specific terms were found.

### BACKGROUND

1. Technical Field

The system and method disclosed herein relates to the field of Internet searching and, more specifically, to a system and method for presenting Internet search results.

2. Description of the Related Art

Users conducting searches on the Internet are often looking not just for a specific site or document, but for the location in the resulting document that contains the search terms, be they a single word or a collection of words in the form of a phrase. When the user follows a link to an identified site or document, they are conventionally taken to the top of the document, rather than to the portion that contains the search terms. The user may be able to find the search terms by performing an additional search on the resulting document, but this can be time-consuming for long documents. Moreover, due to the differences in search algorithms, redirection by search sites, or changes in content, the user at times cannot locate the search terms within the body of the document.

Existing search engines, such as Google and Bing, present extracts of resulting documents, as a part of initial search results. These extracts are selected to include one or more of the search terms, which may be highlighted. This provides a partial solution, but the extracts are so brief that they often do not provide sufficient context. In addition, actually locating the search terms within the target document can be problematic, as described above.

U.S. Patent Application Publication 2009/0132500, issued to Jones et al., describes a means for increasing the effectiveness of Internet searching through the use of “ambassador guides.” These guides are actually humans who categorize and structure a request, interact with the user, provide a search result, and review the search result. This includes the option of the guide formatting the search results. While the efficiency of the user might be dramatically increased with this approach, the requirement for a human guide limits the scalability of this solution and makes the solution an expensive one to operate.

U.S. Patent Application Publication 2009/0089687, issued to Lecomte et al., focuses on a keyboard-based navigation of search results. One aspect of the disclosed concept, however, is to allow a user to invoke, through preferences and corresponding actions, a link-summary operation. For example, the user might hover the cursor over a link, which would cause the system to retrieve additional details about the page being linked to. The additional details might be a summary of the entire page. The summary presentation still may not deal with the information the user is searching for, as the user may be looking for some specific detail that is contained in a document with a different primary focus.

Thus, there is a need to present the results of Internet searches that direct users to specific locations where their search terms can be found in the resulting documents.

### SUMMARY

In accordance with the present invention, a copy of Internet content is modified, as a result of a user's search, to mark the locations of the user's search terms, and the user is provided with one or more links that will direct the user's browser to the locations in the document where the search-specific terms or phrases are found.

More particularly, one embodiment of the present invention involves a term-specific navigation method for information searching by a user of an Internet browser, comprising the steps of: modifying, by using a processor, a copy of Internet content identified as a result of a specific user's search to mark in that copy locations of a user's search terms; and providing the user with one or more links that will direct the user's browser to the locations in the copy where the user-specific terms were found.

Preferably the Internet content comprises a document in which the location is identified by a Uniform Resources Locator (URL) pointing to the head of the document. The document may be modified to insert the marks prior to delivery of the document to the user's browser. In the alternative, the cached copy of the document is accessible to the search engine performing the user's search and that cached copy is utilized to create a modified copy.

In an alternative form, the present invention comprises a term-specific navigation system for information searching by a user of an Internet browser, comprising: a user's browser and a search engine, the search engine including a processor program to modify a copy of Internet content identified as a result of a specific user's search conducted on the user's browser to mark in that copy the locations of a user's search terms and provide the user with one or more links that will direct the user's browser to the locations in the copy where the user's specific terms are found.

It is important to understand that both the foregoing general description and the following detailed description are exemplary and explanatory only, and are not restrictive of the invention as claimed.

### BRIEF DESCRIPTION OF THE DRAWINGS

The accompanying drawings, which are incorporated in and constitute a part of this specification, illustrate various embodiments. In the drawings:

FIG. 1 illustrates the overall system architecture for search term-specific navigation according to the teachings of the present invention.

FIG. 2 provides a comparison of search results from a traditional search engine and the results augmented with term-specific navigation according to the teachings of the present invention.

FIG. 3 provides a comparison of an original HTML code of a hypothetical Internet document and a customized version of the document that allows term-specific navigation according to the teachings of the present invention.

FIG. 4 illustrates a multiframe display wherein the customized document appears on the right-hand side of the screen and the left-hand side of the screen allows for navigation to one or more positions in that document, where original search terms appear.

### DESCRIPTION OF THE EMBODIMENTS

In the following description, for purposes of explanation and not limitation, specific techniques and embodiments are set forth, such as particular sequences of steps, interfaces, and configurations, in order to provide a thorough understanding of the techniques presented herein. While the techniques and embodiments will primarily be described in the context of the accompanying drawings, those skilled in the art will further appreciate that the techniques and embodiments can also be practiced in other electronic devices or systems.

Reference will now be made in detail to exemplary embodiments of the present invention, examples of which are illustrated in the accompanying drawings.

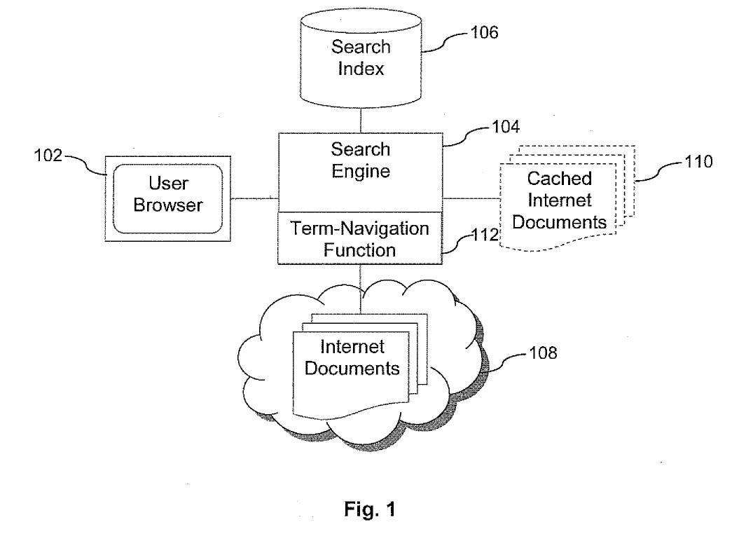

Conventionally, as shown in FIG. 1, a user makes use of an Internet browser application 102 to query a search engine 104 using a set of search terms and/or phrases, hereinafter referred to as user's search terms. Conventional search engines use known tools to crawl the Internet investigating the Internet documents 108 for those containing or related to the user's search terms. The resulting documents may be referred to as Internet content and may comprise documents in which the location is identified by a Uniform Resources Locator (URL) pointing to the head of that document. A search index 106 stores the words and phrases contained in the various Internet documents with links to indicate the location of the corresponding documents. Search engine 104 explores search index 106 to located documents related to the user's search terms.

The search engine 104 might optionally have access to cached versions 110 of the Internet documents as they existed when the search index 106 was created. In response to the query from the user browser, the search engine uses the data in the search index 106, with suitable searching and ranking algorithms, to identify the documents that meet the user's criteria and return a list of documents to the user. The list of documents may include various information from each of the identified Internet documents, such as the title of the document, the Internet location of the document specified as a URL, and an extract of portions of the document's content. This description is in line with existing behavior of search engines.

In accordance with the present invention, a processor associated with the search engine executes a term-navigation function 112 that modifies a copy of the Internet content identified as a result of a specific user's search to mark in that copy the locations of the user's search terms. Thereafter, the user is provided with one or more links that will direct the user's browser 102 to the locations in the copy where the user's specific terms were found.

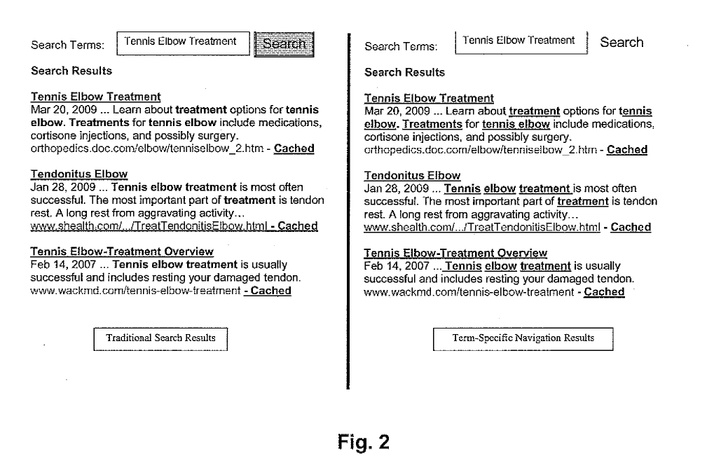

In other words, in case of the present invention, the information returned to the user includes special links that will allow the user to jump, not to the head of the document, but to the locations in the document where the search words or phrases are located. These links might be built into the extracts, for example, by highlighting the search words or phrases in the search results list, as shown in FIG. 2. More specifically, the left-hand side of FIG. 2 shows conventional search engine results that include various extracts with search terms highlighted. The right-hand side of FIG. 2 shows the same extracts with terms in this case underlined, thereby indicating that there is a link from those terms to the location in the document at which these terms reside. It is not necessary to use underlining as link indicators, as highlighting or other forms of identification may be employed to indicate to the user that suitable links are available to move to the particular location in the document where the search terms can be found.

It should be understood that the URLs behind the links to specific keywords do not necessarily point directly to the target document, but rather may direct the browser to a special query back to the search engine. The search engine can then deliver a customized version of the target Internet document that has been modified to allow navigation within that document.

If the term-specific navigation function of the present invention has access to cached copies of the relevant Internet documents, it can create customized versions using those copies. Alternatively, the term-specific navigation function of the present invention can retrieve the relevant Internet documents in response to the user's requests for term-specific navigation and modify the documents prior to delivering them to the user's browser.

The modification performed by the term-specific navigation function of the present invention is to mark the location or locations within documents where the search term or terms appear. This can be accomplished, for example, by inserting “named anchors” within an HTML document at locations near the spot where the search terms and/or phrases appear.

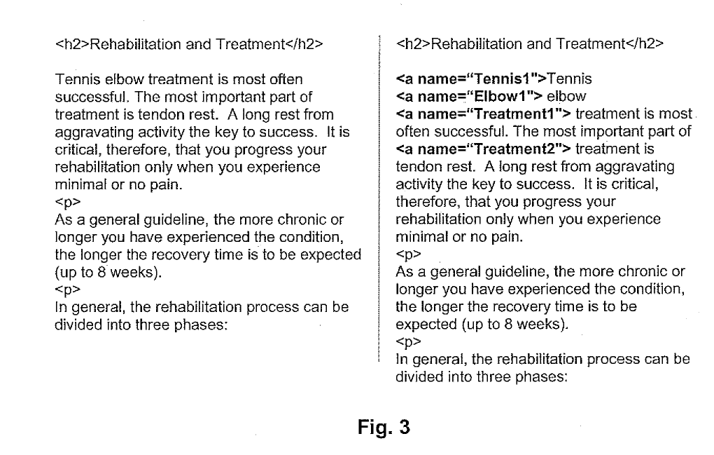

FIG. 3, for example, illustrates an original HTML copy for a sample Internet document on the left-hand side and a customized code where the named anchors have been added on the right-hand side. The URL address used to retrieve the customized documents will include both the location of the document as well as the name of the specific named anchors. For example, for a search at the search engine www.foo.com, pointing to the second instance of the term “treatment” in the second document returned in a search for “tennis elbow treatment” might for example look like: www.foo.com/TennisElbowTreatmentSearchB#Treatment2, where the part in front of the # sign is the location used to represent a specific file, and the portion after the # sign is the name of the anchor.

The user's browser retrieves the document based on the first portion of the URL, then jumps to the point in the document that contains the anchor when it presents the result to the user.

A document likely has links to other sites. These links in the original document need not be modified, so if a user clicks a link in the customized document, the user will navigate to the location specified by the original document, and the search engine and the term navigation function will not be involved in any subsequent interaction. One option would be to modify all those links so that they direct the browser to make a request for the corresponding content back through the search engine. The alternative described here is to leave them unaltered, so the browser will request them from the original source

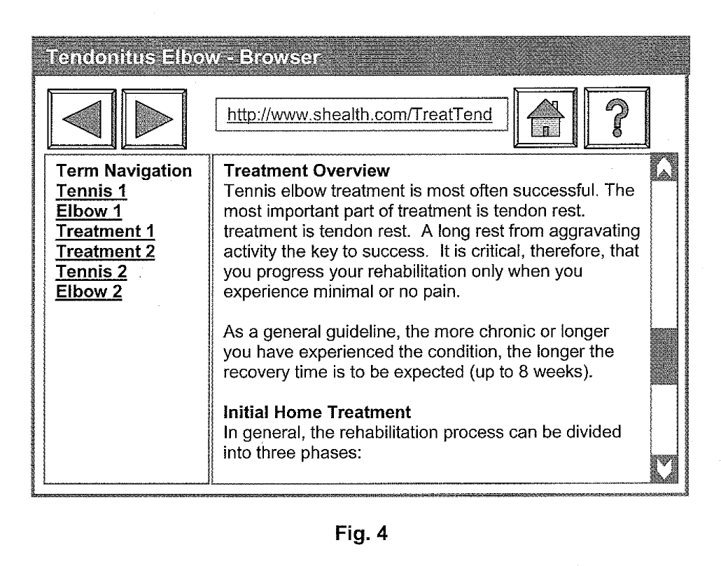

The example in FIG. 3 shows how to add anchors to an HTML code. Similar capabilities exist for other document types, such as “named destinations” in PDF documents. Also, the customized document could be presented in one frame with the links to the named anchors shown in an adjacent frame, as indicated in FIG. 4. This enables the user to easily navigate to the possible multiple locations where the search terms appear.

The present invention is not limited to a user clicking the link and navigating to the indicated portion of the target document. The highlighted search terms could be activated in a pop-up window, or the indicated portion of the document could be displayed in a preview mode. This method of display could be used in place of, or in conjunction with, the ability to navigate to the location of the term in the document.

Thus, it should be understood that the present invention may take the form of a system and/or a related method. It is also understood that the present invention may take the form of a computer-readable storage medium comprising instructions that, when executed in a system, causes the system to perform a method for providing search results, comprising the steps of: modifying a copy of Internet content identified as a result of a specific user's search to mark in that copy the locations of a user's search terms; and providing the user with one or more links that will direct the user's browser to the locations in the copy where the user's specific terms were found.

The foregoing description has been presented for purposes of illustration. It is not exhaustive and does not limit the invention to the precise forms or embodiments disclosed. Modifications and adaptations of the invention can be made from consideration of the specification and practice of the disclosed embodiments of the invention. For example, one or more steps of methods described above may be performed in a different order or concurrently and still achieve desirable results.

Other embodiments of the invention will be apparent to those skilled in the art from consideration of the specification and practice of the invention disclosed herein. It is intended that the specification and examples be considered as exemplary only, with a true scope of the invention being indicated by the following claims.

What is claimed is:

1. A term-specific navigation method for information searching by a user of an Internet browser, comprising the steps of:
modifying, by using a processor, a copy of Internet content identified as a result of a specific user's search to mark in that copy the locations of a user's search terms; and
providing the user with one or more links that will direct the user's browser to the locations in the copy where the user's specific terms were found.

2. The method of claim 1 wherein the Internet content comprises a document whose location is identified by a Uniform Resources Locator (URL) pointing to the head of that document.

3. The method of claim 2 wherein a copy of said document is modified to insert said marks prior to delivery of said document to the user's browser.

4. The method of claim 2 wherein a cached copy of said document is accessible to a search engine performing said user's search and said cached copy is utilized to create said modified copy.

5. The method of claim 1 wherein said step of providing includes sending a display signal to said user that permits display of extracts of said document containing said user's search terms with said links built into said extracts, whereby clicking on said search terms moves said user to the locations of said search terms in said document.

6. The method of claim 2 wherein said user's search terms are identified by underlining in said display.

7. The method of claim 1 wherein said step of modifying a copy of Internet content identified as a result of a specific user's search to mark in that copy the location of a user's search terms includes inserting named anchors within an HTML copy of said document at locations near the spots where the user's search terms appear.

8. The method of claim 7 wherein said step of providing includes sending a display signal to said user that permits display of said document in one frame and a listing of said named anchors in another frame.

9. A term-specific navigation system for information searching by a user of an Internet browser, comprising:
a user's browser; and
a search engine, said search engine including a processor programmed to:
modify a copy of Internet content identified as a result of a specific user's search conducted on said user's browser to mark in that copy the locations of a user's search terms; and
provide the user with one or more links that will direct the user's browser to the locations in the copy where the user's specific terms were found.

10. The system of claim 9 wherein the Internet content comprises a document in which the location is identified by a Uniform Resources Locator (URL) pointing to the head of that document.

11. The system of claim 10 wherein said processor is programmed to modify said copy of said document by inserting said marks prior to delivery of said document to the user's browser.

12. The system of claim 10 including storage that includes a cached copy of said document that is accessible to said search engine and said processor is programmed to utilize said cached copy to create said modified copy.

13. The system of claim 9 wherein said processor is programmed to send a display signal to said user's browser that permits display of extracts of said document containing said user's search terms with said links built into said extracts, and wherein said user's browser displays said document at the locations of said search terms in said document upon clicking on said search terms in said extracts.

14. The system of claim 10 wherein said user's search terms are identified by underlining in said display.

15. The system of claim 9 wherein said processor is programmed to insert named anchors within an HTML copy of said document at locations near the spots where the user's search terms appear.

16. The system of claim 15 wherein said processor is programmed to send a display signal to said user's browser that permits display at said user's browser of said document in one frame and a listing of said named anchors in another frame.

17. A computer-readable storage medium comprising instructions that, when executed in a system, causes the system to perform a method for providing search results, comprising the steps of:
modifying a copy of Internet content identified as a result of a specific user's search to mark in that copy the locations of a user's search terms; and
providing the user with one or more links that will direct the user's browser to the locations in the copy where the user's specific terms were found.
